(19) United States
(12) Patent Application Publication
(10) Pub. No.: US 2025/0276288 A1
(43) Pub. Date: Sep. 4, 2025

(54) MULTIVALENT ION CONCENTRATION USING MULTI-STAGE NANOFILTRATION

(71) Applicant: SAUDI WATER AUTHORITY, Riyadh (SA)

(72) Inventors: Christopher Michael FELLOWS, Al-Jubail (SA); Sangho LEE, Al-Jubail (SA); Seungwon IHM, Al-Khobar (SA); Eslam ALWAZNANI, Al-Jubail (SA)

(21) Appl. No.: 19/069,030

(22) Filed: Mar. 3, 2025

Related U.S. Application Data
(60) Provisional application No. 63/560,918, filed on Mar. 4, 2024.

(51) Int. Cl. B01D 61/02; B01D 61/08; C02F 1/44

(52) U.S. Cl. CPC B01D 61/0271; B01D 61/08; C02F 1/442; B01D 2317/022; C02F 2301/046; C02F 2301/08; C02F 2303/22

(57) ABSTRACT

A system and method to increase a ratio of multivalent ions to monovalent ions in a retentate of a multistage nanofiltration system from saline source water. Multiple nanofiltration units can be arranged in a series to selectively remove monovalent ions from the water fed into each nanofiltration stage in the nanofiltration permeate stream while retaining multivalent ions in the nanofiltration reject stream. The methods and systems may produce the concentrated multivalent ion product is suitable for many applications, which includes fertilizer for plants and remineralization of desalinated water.

### CROSS-REFERENCE TO RELATED APPLICATIONS

This application claims the benefit of priority of U.S. Provisional Patent Application No. 63/560,918, filed Mar. 4, 2024, which is hereby incorporated by reference in its entirety.

### BACKGROUND

### A. Field

The disclosure generally relates to the field of extraction of minerals from source water. More particularly method and system for increasing the ratio of divalent or multivalent ions to monovalent ions in an aqueous solution retentate of a multistage nanofiltration system.

### B. Background

Saline water sources (e.g., seawater, brackish water, brine) typically contain a large number of different dissolved ions in the form of minerals. In order to utilize the dissolved ions for various applications, it is desirable to selectively separate the dissolved ions, either alone or in combination with similar ions, with high purity.

Nano-filtration (NF) is a well-known membrane-based pressure-driven separation method that is selective in rejecting different ions from a feed water source, depending, for example, on the size and charge of the ions and their salt diffusion coefficients in water. In general, NF has a higher rejection of divalent and multivalent ions, and a lower rejection of monovalent ions. Therefore, NF can be used for the concentration of multivalent ions, where the multivalent ions of interest in saline water are concentrated in the NF reject (also known as NF retentate or NF concentrate) stream, while a significant portion of the monovalent ions pass through the membrane and are released in the NF permeate stream.

To achieve higher purity and content of the desired divalent and multivalent ions, the concentration of the divalent and multivalent ions should be maximized, and the concentration of monovalent ions should be minimized. Unfortunately, NF membranes do not provide complete separation of divalent and multivalent, and monovalent ions. Moreover, even if a hypothetical ideal NF membrane had 100% rejection of divalent and multivalent ions in the NF retentate and 0% rejection of monovalent ions (e.g., no change in the concentration of monovalent ions between the feed water and the permeate), there would be no dilution of monovalent ions in the reject stream, because 0% of monovalent ions in the NF reject stream indicates that the concentration of these monovalent ions will be the same in the feed and the permeate. Thus, while the retentate would have a greater concentration of divalent and multivalent ions in the NF reject stream, the concentration of monovalent ions will remain the same in the permeate.

This is the case for an ideal NF membrane; as a practical matter, a more typical rejection rate for monovalent ions is in the range of 10%-70% due to at least a portion of the monovalent ions being unable to pass through the NF membrane. As a result, the NF reject monovalent ion concentration can be expected to be greater than in the feed water, albeit not concentrated as much as the divalent and multivalent ions are concentrated due to their nearly 100% rejection by the NF membrane.

Another challenge when increasing the concentration of divalent and multivalent ions in an NF retentate stream is an increase in the risk of scale formation when the ions reach a point of saturation. In order to avoid scale deposition on the NF membranes, usually the membrane concentration process is limited to lower separation levels, with the ion concentration in the NF rejects being kept below a saturation limit (also referred to as the saturation index). This limitation remains a concern even if an anti-sealant has been added to inhibit scale formation on the surface of the NF membranes.

Typically NF separation systems also have had to be limited due to limits on the membrane design and material, such as limits on the maximum permissible operating pressure differential across the membrane, limits on the available total membrane area, and unavoidable regions in the NF membrane design conducive to enhancing scale deposition.

Thus, in order to maximize the ratio of multivalent ions to monovalent ions in a concentrated mineral product, two primary challenges are the lack of reduction of monovalent ion concentration in the NF retentate, and the increasing scale deposition risk (a concern which is amplified in facilities employing multistage NF treatment systems).

Thus, there is a need for a more efficient method and system for the separation of pure minerals from various water sources.

### SUMMARY

Applicants have found a solution to the above-mentioned problems associated with increasing the ratio of divalent or multivalent ions to monovalent ions in a retentate of a multistage nanofiltration system. A method and systems to increase divalent or multivalent ions such as magnesium, and/or calcium from source water are described herein.

In the present disclosure, saline source water may be used as the feed stream into a multistage NF process. To reduce the concentration of the monovalent ions and to reduce the scale deposition risk, between the nano-filtration stages diluent water having a total dissolved solids (TDS) concentration lower than a TDS concentration of the original saline source water, preferably lower salinity water below the World Health Organization (WHO) salinity limit of 1000 mg/L, is introduced into the preceding stage's NF retentate stream. This reduces the concentration of the monovalent ions entering the next NF stage, and reduces the scale deposition risk by reducing the overall ion concentrations in the previous stage's NF reject. In some instances, the diluent water is distilled water, water from a reverse osmosis process, post-treatment product water, first-stage reverse osmosis permeate, and/or any stream of water with a lower TDS than the stream to be diluted.

Notably, while this approach reduces the concentration of both mono and multivalent ions in the previous stage's NF reject before entering the next NF stage, the total mass of ions (typically expressed in milligram equivalents (“quantity”)) in the diluted feed stream is not reduced.

In the next NF stage, because of the higher rejection in nanofiltration units of multivalent ions over monovalent ions, and further because the ratio of multivalent ions to monovalent ions previously had been substantially increased in the upstream NF stage's processing, the concentration of monovalent ions in the downstream stage's NF reject stream is further reduced relative to the multivalent ions that still remain in downstream stage's NF reject. Thus, the ratio of multivalent ions to monovalent ions in the downstream stage's NF reject is greater than in the upstream stage's NF reject stream.

The present disclosure includes embodiments in which “n” multiple NF stages are arranged in a similar manner, preferably with lower salinity water being supplied between each NF stage to reduce the risk of scaling and further decrease the monovalent ion concentration. The number of NF stages may be determined by the amount of concentration ratio increase desired to be obtained, e.g., by adding NF stages until the desired ratio of multivalent ions to monovalent ions is reached.

While generally preferred, the addition of lower salinity water to the previous stage's NF reject need not to be made before every subsequent NF stage. In addition, where the concentrations of the NF stages' permeate and/or reject streams support such use, a portion of a permeate and/or a reject stream may be recycled into an NF unit feed stream as a further concentration reduction measure. Examples of such alternative arrangement embodiments are discussed further in the following description of example embodiments of the present disclosure.

Different types of NF membranes may be utilized for different stages, depending on the desired final product and facility design constraints. For example, some NF membranes have similar rejection for Ca++ and Mg++ (on the order of 70-98%), while other NF membranes have lower rejection for Ca++ (30-70%) and equal or greater rejection for Mg++ (70-85%). The ratio of Ca to Mg therefore may be managed by the selection and/or mixing of NF process stages of different types. This can be of particular importance when the product is ultimately to be used for plant irrigation, an application in which where it is often critical to maintain a particular target ratio for specific minerals.

In some aspects, a method to increase a ratio of multivalent ions to monovalent ions in a retentate of a multistage nanofiltration system is disclosed herein. In some instances, the method comprises:
filtering a saline source water through a plurality of nanofiltration (NF) units in series, wherein each of the plurality of NF units in the series receives a feed water and forms a NF permeate stream and a NF retentate stream, wherein the feed water of a first NF unit of the plurality of NF units comprises the saline source water; and
optionally diluting the NF retentate stream from one or more of the plurality of NF units with a diluent water to form a diluted NF retentate stream comprising a ratio of the diluent water to the NF retentate stream of 0:1 to 5:1, and wherein the diluent water comprises a total dissolved solids (TDS) concentration lower than a TDS concentration of the saline source water, and
filtering the NF retentate stream and/or diluted NF retentate stream through one or more of the plurality of NF units, wherein the plurality of NF units are configured such that the feed water for NF units downstream of the first NF unit comprises a NF retentate stream and/or diluted NF retentate stream, and
wherein, the volume of the NF permeate stream divided by the volume of the feed water provides a recovery rate (RR), the RR of the first NF unit is greater than the RR of one or more of the subsequent NF units in the series, wherein the RR of the first NF unit is greater than about 60%, the RR of an optional intermediate NF unit in the series is about 20-60%, and the RR of a last NF unit in the series is less than about 60%.

In some aspects, the series comprises at least three NF units, and wherein the filtering comprises a RR of the first NF unit of greater than or equal to 60-80%, the RR of a second and/or one or more intermediate NF unit(s) of about 20-60%, and the RR of the last NF unit of about 20-60%. In some aspects, the filtering comprises a RR of the first NF unit of about 70-80%, preferably about 75%, the RR for the second and/or the intermediate NF unit(s) of about 40-60%, preferably about 50%, and the RR for the last NF unit of about 30-40%, preferably about 35%. In some aspects, the filtering comprises a RR of the first NF unit of about 70-80%, preferably about 75%, the RR for the second and/or the intermediate NF unit(s) of about 25-35%, preferably about 30%, and the RR for the last NF unit of about 25-35%, preferably about 30%. In some aspects, the series comprises at least four NF units, and wherein the filtering comprises a RR of the first NF unit of about 70-80%, preferably about 75%, the RR for a second NF unit of about 45-55%, preferably about 50%, the RR for a third NF unit of about 45-55%, preferably about 50%, and the RR for the last NF unit of about 25-35%, preferably about 30%.

In some aspects, the NF retentate stream from the last NF unit comprises a ratio of multivalent ions to monovalent ions that is increased by at least 200% as compared to a ratio of multivalent ions to monovalent ions in the saline source water.

In some aspects, the NF retentate stream from the last NF unit comprises a concentration of Na at least 10 times lower than the saline source water and/or a concentration of Cl at least 10 times lower than the saline source water.

In some instances, diluting one or more of the NF retentate streams does not produce a diluted NF retentate stream comprising a multivalent ion scaling concentration of CaSO4 that is greater than 250% of a CaSO₄ saturation concentration.

In some instances, one or more of the NF unit(s) further comprise at least 2 nanofiltration stages, optionally wherein the first NF unit comprises at least 2 nanofiltration stages.

In some aspects, the first NF unit is configured to receive greater than or equal to about two times, or about three times an amount of feed water flow or volume relative to one or more downstream NF unit(s), and/or the first NF unit comprises greater than or equal to about two times, or about three times a number of pressure vessels in the first NF unit relative to a number of pressure vessels in one or more downstream NF unit(s).

In some aspects, the NF retentate stream from one or more of the plurality of NF units is mixed with the diluent water to form a diluted NF retentate stream comprising a ratio of the diluent water to the NF retentate of less than 2:1, less than 1:1, or less than 0.5:1, preferably wherein the diluent water to NF retentate is about 0.3:1 to about 0.9:1.

In some aspects, the series further comprises recirculating at least a portion of a NF retentate stream from one or more of the NF units into the feed water of at least one upstream NF unit.

In another aspect, a system to increase a ratio of multivalent ions to monovalent ions in a retentate of a multistage nanofiltration system is disclosed herein. In some instances, the system comprises:
a plurality of nanofiltration (NF) units in series, wherein each of the plurality of NF units in the series are configured to receive a feed water and form a NF permeate stream and a NF retentate stream, wherein the feed water of a first NF unit of the plurality of NF units is configured to receive a saline source water; and
optionally the plurality of NF units are configured such that the NF retentate stream from one or more of the plurality of NF units can be mixed with a diluent water having a total dissolved solids (TDS) concentration lower than a TDS concentration of the saline source water, to form a diluted NF retentate stream comprising a ratio of the diluent water to the NF retentate stream of 0:1 to 5:1,
wherein the plurality of NF units are configured such that the feed water for NF units downstream of the first NF unit comprises a NF retentate stream and/or diluted NF retentate stream, and
wherein, the volume of the NF permeate stream divided by the volume of the feed water provides a recovery rate (RR), the RR of the first NF unit is greater than the RR of one or more of the subsequent NF units in the series, wherein the RR of the first NF unit is greater than about 60%, the RR of an optional second and/or an intermediate NF unit in the series is about 20-60%, and the RR of a last NF unit in the series is less than about 60%.

In some aspects, the series comprises at least three NF units, and wherein the RR of the first NF unit is greater than or equal to 60-80%, the RR of a second NF unit and/or an intermediate NF unit(s) is about 20-60%, and the RR of the last NF unit is about 20-60%. In some instances, the RR of the first NF unit is about 70-80%, preferably 75%, the RR for the second and/or the intermediate NF unit(s) is about 40-60%, preferably about 50%, and the RR for the last NF unit is about 30-40%, preferably about 35%. In some instances, the RR of the first NF unit is about 70-80%, preferably about 75%, the RR for the second and/or the intermediate NF unit(s) is about 25-35%, preferably about 30%, and the RR for the last NF unit is about 25-35%, preferably about 30%. In some instances, the series comprises at least four NF units, and wherein the RR for the first NF unit is about 70-80%, preferably about 75%, the RR for a second NF unit is about 45-55%, preferably about 50%, the RR for a third NF unit is about 45-55%, preferably about 50%, and the RR for the last NF unit is about 25-35%, preferably about 30%.

In some aspects, the system is configured such that the NF retentate stream from the last NF unit comprises a ratio of multivalent ions to monovalent ions that is increased by at least 200% as compared to a ratio of multivalent ions to monovalent ions in the saline source water. In some aspects, the system is configured such that the NF retentate stream from the last NF unit comprises a concentration of Na at least 10 times lower than the saline source water and/or a concentration of Cl at least 10 times lower than the saline source water. In some aspects, the system is configured such that diluting one or more of the NF retentate streams does not produce a diluted NF retentate stream comprising a multivalent ion scaling concentration of CaSO₄ that is greater than 250% of a CaSO₄ saturation concentration.

In some aspects, one or more of the NF units further comprise at least 2 nanofiltration stages, optionally wherein the first NF unit comprises at least 2 nanofiltration stages.

In some aspects, first NF unit is configured to receive greater than or equal to about two times, or about three times an amount of feed water flow or volume relative to one or more downstream NF unit(s), and/or the first NF unit comprises greater than or equal to about two times, or about three times the number of pressure vessels relative to one or more of the downstream NF unit(s).

In some aspects, the NF retentate stream from one or more of the plurality of NF units is configured to be mixed with the diluent water to form a diluted NF retentate stream comprising a ratio of the diluent water to the NF retentate of less than 2:1, less than 1:1, or less than 0.5:1, preferably wherein the diluent water to NF retentate is about 0.3:1 to about 0.9:1.

In some aspects, the system further comprises piping for recirculating at least a portion of the NF retentate stream from one or more of the NF units into the feed water of at least one upstream NF unit.

Certain embodiments of the present disclosure are characterized through the following enumerated aspects.

Aspect 1 is a method to increase a ratio of multivalent ions to monovalent ions in a retentate of a multistage nanofiltration system, the method comprising: a) filtering a saline source water through a plurality of nanofiltration (NF) units in series, wherein each of the plurality of NF units in the series receives a feed water and forms a NF permeate stream and a NF retentate stream, wherein the feed water of a first NF unit of the plurality of NF units comprises the saline source water; and b) optionally diluting the NF retentate stream from one or more of the plurality of NF units with a diluent water to form a diluted NF retentate stream comprising a ratio of the diluent water to the NF retentate stream of 0:1 to 5:1, and wherein the diluent water comprises a total dissolved solids (TDS) concentration lower than a TDS concentration of the saline source water, and c) filtering the NF retentate stream and/or diluted NF retentate stream through one or more of the plurality of NF units, wherein the plurality of NF units are configured such that the feed water for NF units downstream of the first NF unit comprises a NF retentate stream and/or diluted NF retentate stream, and d) wherein, the volume of the NF permeate stream divided by the volume of the feed water provides a recovery rate (RR), the RR of the first NF unit is greater than the RR of one or more of the subsequent NF units in the series, wherein the RR of the first NF unit is greater than about 60%, the RR of an optional intermediate NF unit in the series is about 20-60%, and the RR of a last NF unit in the series is less than about 60%.

Aspect 2 is the method of aspect 1, wherein the series comprises at least three NF units, and wherein the filtering comprises a RR of the first NF unit of greater than or equal to 60-80%, the RR of a second and/or one or more intermediate NF unit(s) of about 20-60%, and the RR of the last NF unit of about 20-60%.

Aspect 3 is the method of aspect 2, wherein the filtering comprises a RR of the first NF unit of about 70-80%, preferably about 75%, the RR for the second and/or the intermediate NF unit(s) of about 40-60%, preferably about 50%, and the RR for the last NF unit of about 30-40%, preferably about 35%.

Aspect 4 is the method of aspect 2, wherein the filtering comprises a RR of the first NF unit of about 70-80%, preferably about 75%, the RR for the second and/or the intermediate NF unit(s) of about 25-35%, preferably about 30%, and the RR for the last NF unit of about 25-35%, preferably about 30%.

Aspect 5 is the method of aspect 1, wherein the series comprises at least four NF units, and wherein the filtering comprises a RR of the first NF unit of about 70-80%, preferably about 75%, the RR for a second NF unit of about 45-55%, preferably about 50%, the RR for a third NF unit of about 45-55%, preferably about 50%, and the RR for the last NF unit of about 25-35%, preferably about 30%.

Aspect 6 is the method of any one of aspects 1-5, wherein the NF retentate stream from the last NF unit comprises a ratio of multivalent ions to monovalent ions that is increased by at least 200% as compared to a ratio of multivalent ions to monovalent ions in the saline source water.

Aspect 7 is the method of any one of aspects 1-6, wherein the NF retentate stream from the last NF unit comprises a concentration of Na at least 10 times lower than the saline source water and a concentration of Cl at least 10 times lower than the saline source water.

Aspect 8 is the method of any one of aspects 1-7, wherein diluting one or more of the NF retentate streams does not produce a diluted NF retentate stream comprising a multivalent ion scaling concentration of CaSO₄ that is greater than 250% of a CaSO₄ saturation concentration.

Aspect 9 is the method of any one of aspects 1-8, wherein one or more of the NF unit(s) further comprise at least 2 nanofiltration stages, optionally wherein the first NF unit comprises at least 2 nanofiltration stages.

Aspect 10 is the method of any one of aspects 1-9, wherein the first NF unit is configured to receive greater than or equal to about two times, or about three times an amount of feed water flow or volume relative to one or more downstream NF unit(s), and/or the first NF unit comprises greater than or equal to about two times, or about three times a number of pressure vessels in the first NF unit relative to a number of pressure vessels in one or more downstream NF unit(s).

Aspect 11 is the method of any one of aspects 1-10, wherein the NF retentate stream from one or more of the plurality of NF units is mixed with the diluent water to form a diluted NF retentate stream comprising a ratio of the diluent water to the NF retentate of less than 2:1, less than 1:1, or less than 0.5:1, preferably wherein the diluent water to NF retentate is about 0.3:1 to about 0.9:1.

Aspect 12 is the method of any one of aspects 1 to 11, further comprising recirculating at least a portion of a NF retentate stream from one or more of the NF units into the feed water of at least one upstream NF unit.

Aspect 13 is a system to increase a ratio of multivalent ions to monovalent ions in a retentate of a multistage nanofiltration system, the system comprising: a) a plurality of nanofiltration (NF) units in series, wherein each of the plurality of NF units in the series are configured to receive a feed water and form a NF permeate stream and a NF retentate stream, wherein the feed water of a first NF unit of the plurality of NF units is configured to receive a saline source water; and b) optionally the plurality of NF units are configured such that the NF retentate stream from one or more of the plurality of NF units can be mixed with a diluent water having a total dissolved solids (TDS) concentration lower than a TDS concentration of the saline source water, to form a diluted NF retentate stream comprising a ratio of the diluent water to the NF retentate stream of 0:1 to 5:1, wherein the plurality of NF units are configured such that the feed water for NF units downstream of the first NF unit comprises a NF retentate stream and/or diluted NF retentate stream, and c) wherein, the volume of the NF permeate stream divided by the volume of the feed water provides a recovery rate (RR), the RR of the first NF unit is greater than the RR of one or more of the subsequent NF units in the series, wherein the RR of the first NF unit is greater than about 60%, the RR of an optional second and/or an intermediate NF unit in the series is about 20-60%, and the RR of a last NF unit in the series is less than about 60%.

Aspect 14 is the system of aspect 13, wherein the series comprises at least three NF units, and wherein the RR of the first NF unit is greater than or equal to 60-80%, the RR of a second NF unit and/or an intermediate NF unit(s) is about 20-60%, and the RR of the last NF unit is about 20-60%.

Aspect 15 is the system of aspect 14, wherein the RR of the first NF unit is about 70-80%, preferably 75%, the RR for the second and/or the intermediate NF unit(s) is about 40-60%, preferably about 50%, and the RR for the last NF unit is about 30-40%, preferably about 35%.

Aspect 16 is the system of aspect 14, wherein the RR of the first NF unit is about 70-80%, preferably about 75%, the RR for the second and/or the intermediate NF unit(s) is about 25-35%, preferably about 30%, and the RR for the last NF unit is about 25-35%, preferably about 30%.

Aspect 17 is the system of any one of aspects 13-16, wherein the series comprises at least four NF units, and wherein the RR for the first NF unit is about 70-80%, preferably about 75%, the RR for a second NF unit is about 45-55%, preferably about 50%, the RR for a third NF unit is about 45-55%, preferably about 50%, and the RR for the last NF unit is about 25-35%, preferably about 30%.

Aspect 18 is the system of any one of aspects 13-17, wherein the system is configured such that the NF retentate stream from the last NF unit comprises a ratio of multivalent ions to monovalent ions that is increased by at least 200% as compared to a ratio of multivalent ions to monovalent ions in the saline source water.

Aspect 19 is the system of any one of aspects 13-18, wherein the system is configured such that the NF retentate stream from the last NF unit comprises a concentration of Na at least 10 times lower than the saline source water and a concentration of Cl at least 10 times lower than the saline source water.

Aspect 20 is the system of any one of aspects 13-19, wherein the system is configured such that diluting one or more of the NF retentate streams does not produce a diluted NF retentate stream comprising a multivalent ion scaling concentration of CaSO₄ that is greater than 250% of a CaSO₄ saturation concentration.

Aspect 21 is the system of any one of aspects 13-20, wherein one or more of the NF units further comprise at least 2 nanofiltration stages, optionally wherein the first NF unit comprises at least 2 nanofiltration stages.

Aspect 22 is the system of any one of aspects 13-21, wherein the first NF unit is configured to receive greater than or equal to about two times, or about three times an amount of feed water flow or volume relative to one or more downstream NF unit(s), and/or the first NF unit comprises greater than or equal to about two times, or about three times the number of pressure vessels relative to one or more of the downstream NF unit(s).

Aspect 23 is the system of any one of aspects 13-22, wherein the NF retentate stream from one or more of the plurality of NF units is configured to be mixed with the diluent water to form a diluted NF retentate stream comprising a ratio of the diluent water to the NF retentate of less than 2:1, less than 1:1, or less than 0.5:1, preferably wherein the diluent water to NF retentate is about 0.3:1 to about 0.9:1.

Aspect 24 is the system of any one of aspects 13-23, further comprising piping for recirculating at least a portion of the NF retentate stream from one or more of the NF units into the feed water of at least one upstream NF unit.

Aspect 25 is the system of any one of Aspects 13 to 24 for use in the method of any one of Aspects 1 to 12.

Aspect 26 is the method of any one of Aspects 1 to 12, comprising using the system of any one of Aspects 13 to 24.

The terms “about” or “approximately” as used herein are defined as being close to as understood by one of ordinary skill in the art. In one non-limiting embodiment, the terms are defined to be within 10%, preferably within 5%, more preferably within 1%, and most preferably within 0.5%.

The terms “wt. %,” “vol. %,” or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The phrase “and/or” can include “and” or “or.” To illustrate, A, B, and/or C can include: A alone, B alone, C alone, a combination of A and B, a combination of A and C, a combination of B and C, or a combination of A, B, and C.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The compositions, systems, methods, etc. can “comprise,” “consist essentially of,” or “consist of” any of the ingredients, components, steps, materials, etc. disclosed throughout the specification. Compositions, systems, methods, etc. “consisting essentially of” any of the ingredients, components, steps, materials, etc. disclosed limits the scope of the claim to the specified ingredients, components, steps, materials, etc. which do not materially affect the basic and novel characteristic of the claimed inventions.

Other objects, features and advantages of the present disclosure will become apparent from the following figures, detailed description, and examples. It should be understood, however, that the figures, detailed description, and examples, while indicating specific embodiments of inventions of the disclosure, are given by way of illustration only and are not meant to be limiting. Additionally, it is contemplated that changes and modifications within the spirit and scope of the disclosure and associated claims will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present disclosure may become apparent to those skilled in the art with the benefit of the following detailed description and upon reference to the accompanying drawings. While inventions of the disclosure are susceptible to various modifications and alternative forms, specific embodiments thereof are shown by way of example in the drawings. The drawings may not be to scale.

FIG. 1—a flowchart of a multistage nanofiltration system to increase the ratio of divalent or multivalent ions to monovalent ions in a retentate according to one example (option) of the present disclosure.

FIG. 2—a flowchart of a multistage nanofiltration system to increase the ratio of divalent or multivalent ions to monovalent ions in a retentate according to another option of the present disclosure.

FIG. 3—a flowchart of a multistage nanofiltration system to increase the ratio of divalent or multivalent ions to monovalent ions in a retentate according to another option of the present disclosure.

### DETAILED DESCRIPTION

A method and system to increase the ratio of multivalent ions to monovalent ions in a retentate of a multistage nanofiltration system are described herein. The methods and systems may be used in seawater and/or brackish water. The methods and systems include contacting saline source water that contains monovalent ions such as sodium, potassium, chloride, and/or bromide compounds; and multivalent compounds such as magnesium and/or calcium compounds with a multistage nanofiltration system that contains multiple NF units with variable NF membranes in series, to obtain a required multivalent ion compounds enriched solution with reduced monovalent compounds as compared to a similar method or system applied. In some instances, the method or system uses the diluent water in between the NF units to dilute the NF retentate streams of upstream NF units. In some instances, the RR of the first NF unit is greater than the RR of one or more of the subsequent NF units in the series.

These and other non-limiting aspects of the present disclosure and encompassed inventions are discussed in further detail in the following sections.

### A. Method to Increase the Ratio of Multivalent Ions to Monovalent Ions in a Retentate of a Multistage Nanofiltration System

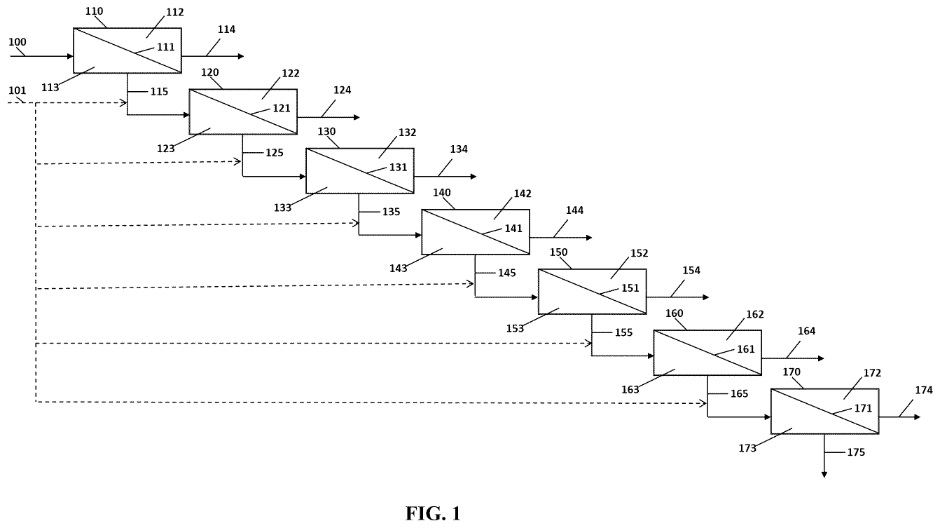

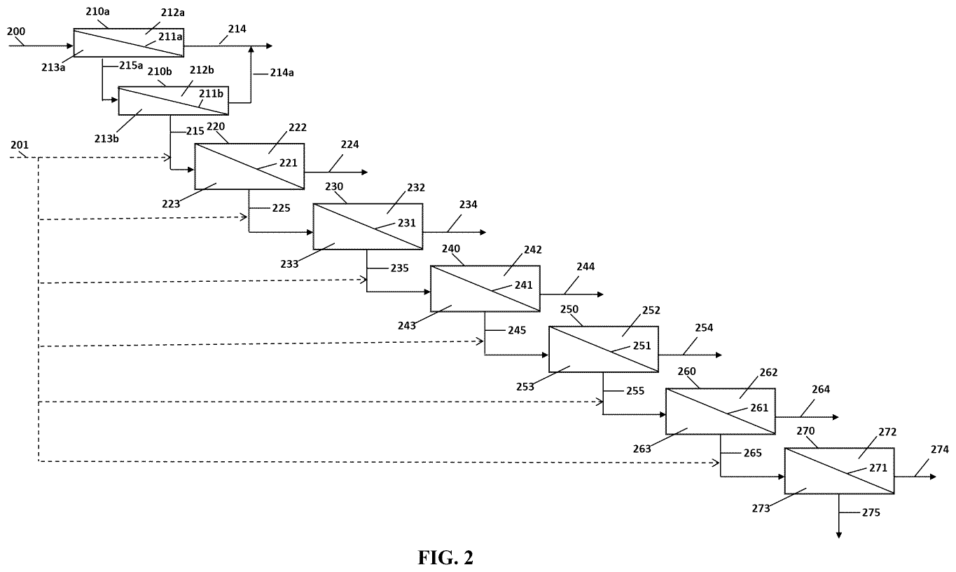

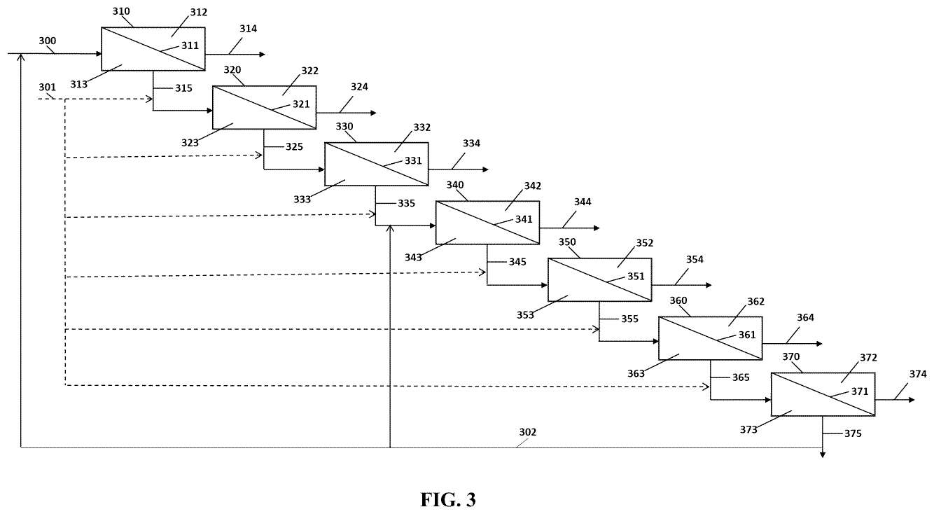

With reference to FIG. 1, FIG. 2, and FIG. 3, a non-limiting methods are disclosed therein to increase the ratio of multivalent ions to monovalent ions in a retentate of a multistage nanofiltration system, the method may include following steps:
filtering saline source water 100, 200, 300 through a plurality of nanofiltration (NF) units 110, 120, 130, 140, 150, 160, 170, 210a, 210b, 220, 230, 240, 250, 260, 270, 310, 320, 330, 340, 350, 360, 370 . . . etc. in series, wherein each of the plurality of NF units in the series receives a feed water and forms NF permeate streams such as 114, 124, 134, 144, 154, 164, 174, 214a, 214, 224, 234, 244, 254, 264, 274, 314, 324, 334, 344, 354, 364, 374 . . . etc. and NF retentate streams such as 115, 125, 135, 145, 155, 165, 175, 215a, 215, 225, 235, 245, 255, 265, 275, 315, 325, 335, 345, 355, 365, 375 . . . etc. wherein the feed water of a first NF unit of the plurality of NF units comprise the saline source water 100,
optionally diluting the NF retentate stream from one or more of the plurality of NF units with a diluent water 101 to form a diluted NF retentate stream comprising a ratio of the diluent water to the NF retentate stream of 0:1 to 5:1, such as any one of, between, greater than, or less than 0:1, 1:1, 2:1, 3:1, 4:1, and 5:1, and wherein the diluent water comprises a total dissolved solids (TDS) concentration lower than a TDS concentration of the saline source water, and
filtering the NF retentate stream and/or diluted NF retentate stream through one or more of the plurality of NF units, wherein the plurality of NF units are configured such that the feed water for NF units downstream of the first NF unit comprises a NF retentate stream and/or diluted NF retentate stream, and wherein, the volume of the NF permeate stream divided by the volume of the feed water provides a recovery rate (RR), the RR of the first NF unit is greater than the RR of one or more of the subsequent NF units in the series, wherein the RR of the first NF unit is greater than about 60%, the RR of an optional intermediate NF unit in the series is about 20-60%, and the RR of a last NF unit in the series is less than about 60%.

FIG. 1 shows an example embodiment of a multistage nanofiltration system. In this embodiment, a saline source water 100, such as seawater, is fed into a first nanofiltration (NF) unit 110 as the first NF unit feed. In the first NF unit 110, a membrane 111 selectively permits monovalent ions such as sodium and chloride to pass to a permeate side 112, leaving multivalent ions such as calcium and magnesium in a retentate side 113 of the first NF unit 110. The first NF permeate stream 114 with a recovery rate greater than or equal to 60-80%, which leaves the first NF unit 110 is transported downstream for further processing and/or use in other applications. The first NF unit reject stream 115, now with greater multivalent-to-monovalent ratio than the saline source water 100, passes out of the first NF unit 110.

Between emerging from the first NF unit 110 and entry as feed water to a second NF unit 120, the first NF unit reject stream 115 is diluted by the addition of lower salinity water such as the diluent water 101 comprises a total dissolved solids (TDS) concentration lower than a TDS concentration of the saline source water 100, which lowers the concentration of both multivalent and monovalent ions, and helps minimize scaling concerns by reducing the stream concentrations to below scaling risk limit concentrations. The diluent water 101 has a lower concentration of minerals than the original saline source water 100. Although diluted, the ratio of multivalent ions to monovalent ions remains the same or close to the same as when the first NF unit reject stream 115 emerges from the first NF unit 110, and the total quantity of the ions (milligram equivalents) in the reject stream is unchanged or nearly unchanged. The present disclosure is not limited to dilution of an upstream NF unit's NF reject before the NF reject enters a downstream NF unit. Alternatively, the lower salinity diluent water may be received in the downstream NF unit's retentate side and mixed with the incoming NF reject stream from the upstream NF unit. In some instances, sufficient dilution occurs near the downstream NF unit's feed inlet to avoid undesirably large localized scale deposition from the incoming undiluted NF reject stream.

As in the first NF unit 110, the diluted first NF unit reject 115 is processed in the second NF unit 120 with monovalent ions traversing the membrane 121. The monovalent ions exit from the permeate side 122 in the second NF permeate 124, while the multivalent ion-rich second NF unit reject stream 125 leaves the second NF unit's retentate side 123. With this second nanofiltration step, the ratio of the concentration of multivalent ions to monovalent ions in the second NF unit reject stream 125 is further increased.

Similar to the second NF unit 120, the diluted second NF unit reject 125 is processed in the third NF unit 130 with monovalent ions traversing the membrane 131. The monovalent ions exit from the permeate side 132 in the third NF permeate 134, while the multivalent ion-rich third NF unit reject stream 135 leaves the third NF unit's retentate side 133. With this third nanofiltration step, the ratio of the concentration of multivalent ions to monovalent ions in the third NF unit reject stream 135 is further increased.

After the third NF unit rejects stream 135 leaves the third NF unit 130, in this embodiment, the lower salinity diluent water is also injected to dilute stream 135 to lower concentrations and avoid scaling. Depending on the facility design and processing requirements, the addition of lower salinity water is not required between every pair of previous and next NF stages. For example, if at the next stage, the scaling risk is already low, further dilution may not be required. Also, in this embodiment, the source of the lower salinity diluent water is shared between all of the stages, but the inter-stage lower salinity diluent water injection may be provided at different locations with different lower salinity diluent water sources. The sources can be chosen to provide sufficient dilution to obtain the desired product. For example, a portion of the low salinity stream from a reverse osmosis (RO) unit may be used at one injection point, thereby making additional utilization of the output from the RO unit. In contrast, a different stream output from another desalination process or other industrial process is used between other NF stages.

There may be “n” number of stages in embodiments of the present disclosure, with the number of stages typically determined by the level of purity desired in the final product from the “nth” NF unit reject stream. In the FIG. 1 embodiment, similar third, fourth, fifth, sixth, and seventh NF units 130, 140, 150, 160, 170 with respective corresponding membranes 131, 141, 151, 161, and 171, permeate sides 132, 142, 152, 162, 172, retentate sides 133, 143, 153, 163, 173, permeate streams 134, 144, 154, 164, 174, and NF reject streams 135, 145, 155, 165, and 175 are illustrated. The final NF unit reject stream 175 has the highest ratio of multivalent to monovalent ions, e.g., high purity, with very low monovalent ion concentrations. This product may be used in a liquid form as-is, may be diluted to suit a particular application, may be further concentrated by liquid removal, dried into a solid form, transported for further processing as a feedstock for another process, and/or otherwise handled to suit a downstream application.

In another embodiment shown in FIG. 2, the first NF unit of a multistage nanofiltration system comprises at least 2 nanofiltration stages such as 210a and 210b with separate nanofiltration membranes 211a and 211b respectively. In some instances, one or more of the other NF units of the multistage nanofiltration system also comprise at least 2 nanofiltration stages.

In another embodiment shown in FIG. 3, at least a portion of any NF unit reject streams such as 315, 325, 335, 345, 355, 365, and 375 is recirculated into the saline source water 300, and/or the feed water of at least one upstream NF unit thereby increasing the amount of multivalent ions in the NF unit's feed and the ratio of multivalent ions to monovalent ions, and helping maintain the concentrations below their respective scaling risk limits. This embodiment shows recirculation of the seventh NF unit reject stream 375 into the saline source water 300 feed and into the reject stream 335, but such recirculation may be directed before and/or between any pair of NF unit stages. The recirculation also does not have to be from the final NF unit stage, but may be from one or more of the intermediate and/or first NF stages.

A quantitative illustration of example system flows and concentrations is presented in Tables 1-4, below, in conjunction with an example of the present disclosure shown in FIG. 1.

Table 1 shows an example of the RR and dilutions at each stage and shows the increase in the ratio of some of the primary multivalent to monovalent ions of interest (Ca+ Mg)/(Na+Cl) in the various NF stages of an embodiment.

Table 2 shows changes in concentrations of key ions at each stage, changes in flow, and changes in ratios of some ions of interest.

In this example, the target increase was achieved in seven NF stages. Additional, or fewer, nanofiltration stages may be used as needed to obtain a desired ratio of multivalent ions to monovalent ions. In another example, the target increase was achieved in twelve NF stages. Additional, or fewer, nanofiltration stages may be used as needed to obtain a desired ratio of multivalent ions to monovalent ions.

Table 3 shows an example of RR and dilutions at each stage of a 12-stage example and shows the increase in the ratio of multivalent to monovalent ions (Ca+ Mg)/(Na+Cl). Table 4 shows examples of changes in concentrations of key ions at each stage, changes in flow, and changes in ratios of some ions of interest.

Appropriate adjustment (or between some stages, even elimination) of the amount of lower salinity water introduced into the intermediate NF reject streams and/or the original saline source water stream, as well as use of different nanofiltration membrane types may also be used to adjust process performance.

The amount of lower salinity water and the amount of recirculated NF reject may be varied as necessary to suit the desired product parameters, for example, by increasing or decreasing the amount of lower salinity water added between different stages. Preferably, the ratio or lower salinity water to NF reject is in the range of 2:1 to 5:1, however, the present disclosure is not limited to these ranges and includes a ratio of 0:1, e.g., no lower salinity water addition between one or more stages. Similarly, the amount of recirculation may be increased or decreased, and/or the recirculation arrangements may be varied, for example, by supplying downstream NF reject to more than one upstream NF reject stream, and/or more than one downstream NF reject stream may be used as a source for recirculation to one or more upstream NF reject streams.

Alternatively, depending on the system needs and design, recirculated NF reject may originate from any of the downstream NF units, up to and including the “n−1th” NF unit at the end of an “n”-length NF unit system.

For example, if an anti-sealant is being added to the NF system to minimize scale deposition, but the presence of the anti-sealant is not desired in the final product, a configuration such eliminates this concern. Similarly, because nanofiltration rejects undesired contaminants such as bacteria, colloids, viruses, and color, a configuration that permits the final product to be free from such contaminants that might be present in the “n−1th” NF unit's NF reject. This arrangement may also result in a lower total dissolved solids content in the final product, and final product might have desirably different ratio of multivalent ions. This latter advantage is due to different NF membranes having different rejections for some same-valent ions (e.g., selective decreasing of the ratio of calcium to magnesium by using an NF membrane with higher rejection performance for magnesium as compared to calcium).

The use of NF permeate as a feed source is not limited to using the “n-1th” NF unit's permeate as the feed into the “nth” NF unit, but may be applied between any of the upstream nanofiltration stages. For example, FIG. 3 is an embodiment of the present disclosure in which the NF reject 335 from the third NF unit 330 along with a recirculated portion 302 of NF reject 375 and a diluent water 301 is fed into the fourth NF unit 340.

The present disclosure is not limited to embodiments in which only a single NF permeate stream is the feed water to a downstream NF unit, but includes embodiments in which more than one NF permeate stream is used as the feed water to one or more downstream NF units.

In some aspects of the present disclosure in which the final stage of the system may include a desalinator/concentrator. This unit is included in the process train after the target ratio of multivalent ion to monovalent ions has been achieved. The ion content of the product water is then concentrated by the desalinator/concentrator to a desired concentration level. Accordingly, the concentrated product may have approximately the same multivalent ion to monovalent ion ratio, in a lower product volume. A desired concentration of a target ratio-satisfying NF reject is not limited to the use of a desalinator/concentrator, but may be performed by any suitable process which reduces the volume of the final NF reject.

The present disclosure provides the capability to concentrate selected multivalent ions relative to monovalent ions in a saline source water, with the ratio of desired multi-valent ions and/or undesired monovalent ions being able to be determined by variations in the system design and operating parameters, e.g., use of different nanofiltration membrane technologies, use of different scaling risk limits, use of different amounts of lower salinity water dilution and/or NF reject recirculation, rearrangement of dilution and/or recirculation injection locations.

The foregoing disclosure has been set forth merely to illustrate the inventions described in the disclosure and is not intended to be limiting. Because such modifications of the disclosed embodiments incorporating the spirit and substance of the inventions may occur to persons skilled in the art, the inventions should be construed to include everything within the scope of the appended claims and equivalents thereof.

Listing of reference labels:

| | |
|---|---|
| 100, 200, 300 | saline source water |
| 101, 201, 301 | diluent water |
| 110, 120, 130, 140, 150, 160, 170, 210, 220, 230, 240, 250, 260, | NF unit |
| 270, 310, 320, 330, 340, 350, 360, 370 | |
| 111, 121, 131, 141, 151, 161, 171, 211, 221, 231, 241, 251, 261, | NF membrane |
| 271 311, 321, 331, 341, 351, 361, 371 | |
| 112, 122, 132, 142, 152, 162, 172, 212, 222, 232, 242, 252, 262, | NF unit permeate side |
| 272 312, 322, 332, 342, 352, 362, 372 | |
| 113, 123, 133, 143, 153, 163, 173, 213, 223, 233, 243, 253, 263, | NF unit retentate side |
| 273, 313, 323, 333, 343, 353, 363, 373 | |
| 114, 124, 134, 144, 154, 164, 174, 214, 224, 234, 244, 254, 264, | NF permeate |
| 274, 314, 324, 334, 344, 354, 364, 374 | |
| 115, 125, 135, 145, 155, 165, 175, 215, 225, 235, 245, 255, 265, | NF reject |
| 275, 315, 325, 335, 345, 355, 365, 375 | |
| 210a, 210b | nanofiltration stages in an NF unit |
| 302 | recirculating NF retentate stream |

In some aspects, the series comprises at least three NF units, and wherein the filtering comprises a RR of the first NF unit of greater than or equal to 60-80%, such as 60, 65, 70, 75, 80%, the RR of a second and/or one or more intermediate NF unit(s) of about 20-60%, such as 20, 25, 30, 35, 40, 45, 50, 55, 60%, and the RR of the last NF unit of about 20-60%, such as 20, 25, 30, 35, 40, 45, 50, 55, 60%. In some aspects, the filtering comprises a RR of the first NF unit of about 70-80%, such as 70, 71, 72, 73, 74, 75, 76, 77, 78, 79, 80%, preferably about 75%, the RR for the second and/or the intermediate NF unit(s) of about 40-60%, such as 40, 41, 42, 43, 44, 45, 46, 47, 48, 49, 50, 51, 52, 53, 54,55, 56, 57, 58, 59, 60%, preferably about 50%, and the RR for the last NF unit of about 30-40%, such as 30, 31, 32, 33, 34, 35, 36, 37, 38, 39, 40%, preferably about 35%. In some aspects, the filtering comprises a RR of the first NF unit of about 70-80%, such as 70, 71, 72, 73, 74, 75, 76, 77, 78, 79, 80%, preferably about 75%, the RR for the second and/or the intermediate NF unit(s) of about 25-35%, such as 25, 26, 27, 28, 29, 30, 31, 32, 33, 34, 35%, preferably about 30%, and the RR for the last NF unit of about 25-35%, such as 25, 26, 27, 28, 29, 30, 31, 32, 33, 34, 35%, preferably about 30%. In some aspects, the series comprises at least four NF units, and wherein the filtering comprises a RR of the first NF unit of about 70-80%, such as 70, 71, 72, 73, 74, 75, 76, 77, 78, 79, 80%, preferably about 75%, the RR for a second NF unit of about 45-55%, such as 45, 46, 47, 48, 49, 50, 51, 52, 53, 54,55%, preferably about 50%, the RR for a third NF unit of about 45-55%, such as 45, 46, 47, 48, 49, 50, 51, 52, 53, 54,55%, preferably about 50%, and the RR for the last NF unit of about 25-35%, such as 25, 26, 27, 28, 29, 30, 31, 32, 33, 34, 35%, preferably about 30%.

In some aspects, the NF retentate stream from the last NF unit comprises a ratio of multivalent ions to monovalent ions that is increased by at least 200%, such as 250, 300, 350, 400, 450, 500, 550, 600, 650, 700, etc., as compared to a ratio of multivalent ions to monovalent ions in the saline source water.

In some aspects, the NF retentate stream from the last NF unit comprises a concentration of Na at least 10 times lower, such as 12, 14, 16, 18, 20, 25, 30, 35, 40, 45, 50, etc., than the saline source water and/or a concentration of Cl at least 10 times lower, such as 12, 14, 16, 18, 20, 25, 30, 35, 40, 45, 50, etc., than the saline source water.

In some instances, diluting one or more of the NF retentate streams does not produce a diluted NF retentate stream comprising a multivalent ion scaling concentration of CaSO₄ that is greater than 250% of a CaSO₄ saturation concentration, such as 240, 230, 220, 210, 200, 175, 150, 125, 100, 75, etc.

In some instances, one or more of the NF unit(s) further comprise at least 2 nanofiltration stages, optionally wherein the first NF unit comprises at least 2 nanofiltration stages, such as 3, 4, 5, 6, 7, 8, 9, 10, 11, 12, 13, 14, 15, 16, 17, 18, 19, 20, etc.

In some aspects, the first NF unit is configured to receive greater than or equal to about two times, or about three times, four times, five times, etc. an amount of feed water flow or volume relative to one or more downstream NF unit(s), and/or the first NF unit comprises greater than or equal to about two times, or about three times, four times, five times, etc. a number of pressure vessels in the first NF unit relative to a number of pressure vessels in one or more downstream NF unit(s), such as 4, 5, 6, 7, 8, 9, 10, etc.

In some aspects, the NF retentate stream from one or more of the plurality of NF units is mixed with the diluent water to form a diluted NF retentate stream comprising a ratio of the diluent water to the NF retentate of less than 2:1, less than 1:1, or less than 0.5:1, preferably wherein the diluent water to NF retentate is about 0.3:1 to about 0.9:1, such as 0.8:1, 0.7:1, 0.6:1, 0.5:1, 0.4:1, 0.3:1, 0.2:1, 0.1:1, etc.

In some aspects, the series further comprises recirculating at least a portion of a NF retentate stream from one or more of the NF units into the feed water of at least one upstream NF unit.

### B. System to Increase the Ratio of Multivalent Ions to Monovalent Ions in a Retentate of a Multistage Nanofiltration System

With reference to FIG. 1, FIG. 2, and FIG. 3, non-limiting systems are disclosed therein to increase the ratio of multivalent ions to monovalent ions in a retentate of a multistage nanofiltration system.

The system may include a plurality of nanofiltration (NF) units in series such as 110, 120, 130, 140, 150, 160, 170, 210a, 210b, 220, 230, 240, 250, 260, 270, 310, 320, 330, 340, 350, 360, 370, etc., wherein each of the plurality of NF units in the series are configured to receive a feed water and form a NF permeate stream such as 114, 124, 134, 144, 154, 164, 174, 214a, 214, 224, 234, 244, 254, 264, 274, 314, 324, 334, 344, 354, 364, 374 . . . etc., and a NF retentate stream such as 115, 125, 135, 145, 155, 165, 175, 215a, 215, 225, 235, 245, 255, 265, 275, 315, 325, 335, 345, 355, 365, 375 . . . etc., wherein the feed water of a first NF unit of the plurality of NF units is configured to receive a saline source water 100, 200, 300.

In some instances, the plurality of NF units are configured such that one or more NF retentate streams from one or more of the plurality of NF units can be mixed with a diluent water 101, 201, 301 having a total dissolved solids (TDS) concentration lower than a TDS concentration of the saline source water 100, 200, 300 to form a diluted NF retentate stream comprising a ratio of the diluent water to the NF retentate stream of 0:1 to 5:1. In some instances, the plurality of NF units are configured such that the feed water for NF units downstream of the first NF unit comprises a NF retentate stream and/or diluted NF retentate stream. In some instances, the volume of the NF permeate stream divided by the volume of the feed water provides a recovery rate (RR), the RR of the first NF unit being greater than the RR of one or more of the subsequent NF units in the series, wherein the RR of the first NF unit is greater than about 60%, such as about 65, 70, 75, 80%, the RR of an optional second and/or an intermediate NF unit in the series is about 20-60%, such as 20, 25, 30, 35, 40, 45, 50, 55, 60%, and the RR of a last NF unit in the series is less than about 60%, such as 10, 15, 20, 25, 30, 35, 40, 45, 50, 55%,.

In some aspects, the series comprises at least three NF units wherein the RR of the first NF unit is greater than or equal to 60-80%, such as 60, 65, 70, 75, 80%, the RR of a second NF unit and/or an intermediate NF unit(s) is about 20-60%, such as 20, 25, 30, 35, 40, 45, 50, 55, 60%, and the RR of the last NF unit is about 20-60%, such as 20, 25, 30, 35, 40, 45, 50, 55, 60%. In some aspects, the RR of the first NF unit is about 70-80%, such as 70, 71, 72, 73, 74, 75, 76, 77, 78, 79, 80%, preferably 75%, the RR for the second and/or the intermediate NF unit(s) is about 40-60%, such as 40, 41, 42, 43, 44, 45, 46, 47, 48, 49, 50, 51, 52, 53, 54,55, 56, 57, 58, 59, 60%, preferably about 50%, and the RR for the last NF unit is about 30-40%, such as 30, 31, 32, 33, 34, 35, 36, 37, 38, 39, 40%, preferably about 35%. In some aspects, the RR of the first NF unit is about 70-80%, such as 70, 71, 72, 73, 74, 75, 76, 77, 78, 79, 80%, preferably about 75%, the RR for the second and/or the intermediate NF unit(s) is about 25-35%, such as 25, 26, 27, 28, 29, 30, 31, 32, 33, 34, 35%, preferably about 30%, and the RR for the last NF unit is about 25-35%, such as 25, 26, 27, 28, 29, 30, 31, 32, 33, 34, 35%, preferably about 30%.

In some aspects, the series comprises at least four NF units and the RR for the first NF unit is about 70-80%, such as 70, 71, 72, 73, 74, 75, 76, 77, 78, 79, 80%, preferably about 75%, the RR for a second NF unit is about 45-55%, such as 45, 46, 47, 48, 49, 50, 51, 52, 53, 54,55%, preferably about 50%, the RR for a third NF unit is about 45-55%, such as 45, 46, 47, 48, 49, 50, 51, 52, 53, 54,55%, preferably about 50%, and the RR for the last NF unit is about 25-35%, such as 25, 26, 27, 28, 29, 30, 31, 32, 33, 34, 35%, preferably about 30%.

In some aspects, the system is configured such that the NF retentate stream from the last NF unit comprises a ratio of multivalent ions to monovalent ions that is increased by at least 200% %, such as 250, 300, 350, 400, 450, 500, 550, 600, 650, 700, etc., as compared to a ratio of multivalent ions to monovalent ions in the saline source water.

In some aspects, the system is configured such that the NF retentate stream from the last NF unit comprises a concentration of Na at least 10 times lower, such as 12, 14, 16, 18, 20, 25, 30, 35, 40, 45, 50, etc., than the saline source water and a concentration of Cl at least 10 times lower, such as 12, 14, 16, 18, 20, 25, 30, 35, 40, 45, 50, etc., than the saline source water.

In some aspects, the system is configured such that diluting one or more of the NF retentate streams does not produce a diluted NF retentate stream comprising a multivalent ion scaling concentration of CaSO₄ that is greater than 250% of a CaSO₄ saturation concentration, such as 240, 230, 220, 210, 200, 175, 150, 125, 100, 75, etc.

In some aspects, one or more of the NF units further comprise at least 2 nanofiltration stages, optionally wherein the first NF unit comprises at least 2 nanofiltration stages such as 210a and 210b shown in FIG. 2.

In some aspects, the first NF unit is configured to receive greater than or equal to about two times, or about three times, four times, five times, etc. an amount of feed water flow or volume relative to one or more downstream NF unit(s) and/or the first NF unit comprises greater than or equal to about two times, or about three times, four times, five times, etc. the number of pressure vessels relative to one or more of the downstream NF unit(s).

In some aspects, the NF retentate stream from one or more of the plurality of NF units is configured to be mixed with the diluent water such as 101, 201, 301 to form a diluted NF retentate stream comprising a ratio of the diluent water to the NF retentate of less than 2:1, less than 1:1, or less than 0.5:1, preferably wherein the diluent water to NF retentate is about 0.3:1 to about 0.9:1, such as 0.8:1, 0.7:1, 0.6:1, 0.5:1, 0.4:1, 0.3:1, 0.2:1, 0.1:1, etc.

In some aspects, the system further comprises piping for recirculating at least a portion of the NF retentate stream such as 302 in FIG. 3 from one or more of the NF units into the feed water of at least one upstream NF unit.

### C. Uses of Concentrated Multivalent Ion Products Separated From Saline Source Water

Concentrated multivalent ion solution and/or sold with minimized monovalent ions has many applications, such as in the field of advanced fertilizers production. In some instances, the applications include drinking water treatment, wastewater treatment, and/or reclaimed water treatment. For example, mitigating monovalent ion removal in a water purification process

The systems and methods disclosed herein provide for an environmentally friendly process to concentrate multivalent ion concentrations such as magnesium and/or calcium, and the removal of monovalent ions such as sodium and/or potassium in water. The systems and methods disclosed herein may be used in industrial-scale multivalent salt production processes. For example, the extracted Mg from saline source water may be added to drinking water according to new regulation on drinking water by the World Health Organization (WHO) (Mg≥5 ppm).

### EXAMPLES

The present disclosure will be described in greater detail by way of specific examples. The following examples are offered for illustrative purposes only, and are not intended to limit the inventions disclosed herein in any manner. Those of skill in the art will readily recognize a variety of noncritical parameters which can be changed or modified to yield essentially the same results.

### Example 1

### Computational Simulation

A multivalent-ion rich stream can be produced by a multistage nanofiltration system, such as a multistage nanofiltration system with seven NF units as in FIG. 1. A computer simulation of such a system was run. When NF1 was fed with saline source water, 13.2 weight % of a combination of Ca²⁺, Mg²⁺, Na⁺, SO₄²⁻ and Cl⁻may be produced in the first NF1 reject stream with 75% of RR. The properties of the reject streams, the RR of each NF unit, and the amount of dilution with distilled water at each NF unit was calculated and presented in Tables 1 and 2. The dilution amount is the amount of the stream that is distilled water, with 1 equaling the whole stream. As an example, a dilution of 0.39 means that the stream is 39% distilled water and 61% of the feed.

TABLE 1

| NF Unit No. | RR % | Dilution | CaMg/NaCl % |
|---|---|---|---|
| 1 | 75 | | (5.6 Seawater) 13.2 |
| 2 | 50 | 0.39 | 21.0 |
| 3 | 50 | 0.84 | 33.5 |
| 4 | 50 | 0.88 | 55.0 |
| 5 | 50 | 0.84 | 90.1 |
| 6 | 50 | 0.92 | 145.1 |
| 7 | 35 | 0.49 | 195.5 |

TABLE 2

| | NF1 | NF1 | NF1 | | NF2 | NF2 | NF2 | |
|---|---|---|---|---|---|---|---|---|
| | Feed | Perm | Rej | Dilute 1 | Feed | Perm | Rej | Dilute 2 |
| Flow | 372.00 | 279.00 | 93 | 36.00 | 129.00 | 64.50 | 64.50 | 54.00 |
| Ca++ | 450 | 245 | 1,066 | 20.0 | 774 | 376 | 1,171 | 20.0 |
| Mg++ | 1,500 | 249 | 5,254 | 0.0 | 3,788 | 562 | 7,014 | 0.0 |
| Na+ | 12,642 | 11,471 | 16,156 | 1.7 | 11,648 | 10,782 | 12,514 | 1.7 |
| K+ | 480 | 436 | 613 | 0.1 | 442 | 409 | 475 | 0.1 |
| Sr++ | 8 | 4 | 19 | 0.0 | 13 | 8 | 19 | 0.0 |
| CO3−− | 28 | 28 | 28 | | 20 | 20 | 20 | |
| HCO3− | 160 | 94 | 358 | 61.2 | 275 | 8 | 392 | 61.2 |
| SO4−− | 3,500 | 21 | 13,938 | 0.0 | 10,048 | 58 | 20,038 | 0.0 |
| Cl− | 22,400 | 19,261 | 31,818 | 2.7 | 22,939 | 19,344 | 26,535 | 2.7 |
| F− | 2 | 2 | 2 | 0.0 | 2 | 1 | 2 | 0.0 |
| NO3− | 2 | 1 | 5 | 0.8 | 4 | 2 | 5 | 0.8 |
| B | 6 | 5 | 6 | 1.3 | 4 | 4 | 4 | 1.3 |
| Br− | 60 | 52 | 85 | 0.0 | 61 | 52 | 71 | 0.0 |
| TDS | 41,237 | 31,867 | 69,348 | 88 | 50,019 | 31,778 | 68,261 | 88 |
| CaMg/NaCl | 5.6% | 1.6% | 13.2% | | 13.2% | 3.1% | 21.0% | |

| | NF3 | NF3 | NF3 | | NF4 | NF4 | NF4 |
|---|---|---|---|---|---|---|---|
| | Feed | Perm | Rej | Dilute 3 | Feed | Perm | Rej |
| Flow | 118.50 | 59.25 | 59.25 | 52.00 | 111.25 | 55.63 | 55.63 |
| Ca++ | 647 | 314 | 979 | 20.0 | 531 | 195 | 867 |
| Mg++ | 3,818 | 566 | 7,069 | 0.0 | 3,765 | 431 | 7,098 |
| Na+ | 6,812 | 6,306 | 7,319 | 1.7 | 3,899 | 3,799 | 3,999 |
| K+ | 259 | 239 | 278 | 0.1 | 148 | 144 | 152 |
| Sr++ | 10 | 6 | 15 | 0.0 | 8 | 5 | 11 |
| CO3−− | 11 | 11 | 11 | | 6 | 6 | 6 |
| HCO3− | 241 | 139 | 343 | 61.2 | 211 | 118 | 305 |
| SO4−− | 10,907 | 63 | 21,751 | 0.0 | 11,584 | 64 | 23,104 |
| Cl− | 14,444 | 12,180 | 16,708 | 2.7 | 8,900 | 7,317 | 10,482 |
| F− | 1 | 1 | 1 | 0.0 | 1 | 1 | 1 |
| NO3− | 3 | 2 | 5 | 0.8 | 3 | 2 | 4 |
| B | 3 | 3 | 3 | 1.3 | 2 | 2 | 2 |
| Br− | 39 | 33 | 45 | 0.0 | 24 | 20 | 28 |
| TDS | 37,195 | 19,863 | 54,526 | 88 | 29,081 | 12,102 | 46,060 |
| CaMg/NaCl | 21.0% | 4.8% | 33.5% | | 33.6% | 5.6% | 55.0% |

| | | NF5 | NF5 | NF5 | |
|---|---|---|---|---|---|
| | Dilute 4 | Feed | Perm | Rej | Dilute 5 |
| Flow | 47.00 | 102.63 | 51.31 | 51.31 | 47.00 |
| Ca++ | 20.0 | 479 | 176 | 782 | 20.0 |
| Mg++ | 0.0 | 3,848 | 441 | 7,254 | 0.0 |
| Na+ | 1.7 | 2,168 | 2,113 | 2,224 | 1.7 |
| K+ | 0.1 | 82 | 80 | 84 | 0.1 |
| Sr++ | 0.0 | 6 | 4 | 8 | 0.0 |
| CO3−− | | 3 | 3 | 3 | |
| HCO3− | 61.2 | 194 | 108 | 279 | 61.2 |
| SO4−− | 0.0 | 12,523 | 69 | 24,977 | 0.0 |
| Cl− | 2.7 | 5,683 | 4,672 | 6,693 | 2.7 |
| F− | 0.0 | 0 | 0 | 0 | 0.0 |
| NO3− | 0.8 | 3 | 1 | 4 | 0.8 |
| B | 1.3 | 2 | 2 | 2 | 1.3 |
| Br− | 0.0 | 15 | 13 | 18 | 0.0 |
| TDS | 88 | 25,006 | 7,681 | 42,330 | 88 |
| CaMg/NaCl | | 55.1% | 9.1% | 90.1% | |

| | NF6 | NF6 | NF6 | | | NF7 | NF7 |
|---|---|---|---|---|---|---|---|
| | Feed | Perm | Rej | Dilute 6 | NF7 Feed | Perm | Rej |
| Flow | 98.31 | 49.16 | 49.16 | 24.00 | 73.16 | 25.60 | 47.55 |
| Ca++ | 418 | 99 | 737 | 20.0 | 501 | 119 | 707 |
| Mg++ | 3,786 | 321 | 7,251 | 0.0 | 4,872 | 413 | 7,273 |
| Na+ | 1,162 | 1,170 | 1,153 | 1.7 | 776 | 781 | 773 |
| K+ | 44 | 45 | 44 | 0.1 | 29 | 30 | 29 |
| Sr++ | 4 | 3 | 6 | 0.0 | 4 | 3 | 5 |
| CO3−− | 2 | 2 | 2 | | 1 | 1 | 1 |
| HCO3− | 175 | 87 | 263 | 61.2 | 197 | 98 | 250 |
| SO4−− | 13,036 | 62 | 26,011 | 0.0 | 17,478 | 83 | 26,844 |
| Cl− | 3,495 | 2,639 | 4,350 | 2.7 | 2,924 | 2,208 | 3,310 |
| F− | 0 | 0 | 0 | 0.0 | 0 | 0 | 0 |
| NO3− | 2 | 1 | 4 | 0.8 | 3 | 1 | 3 |
| B | 2 | 1 | 2 | 1.3 | 2 | 1 | 2 |
| Br− | 9 | 7 | 12 | 0.0 | 8 | 6 | 9 |
| TDS | 22,135 | 4,437 | 39,834 | 88 | 26,795 | 3,745 | 39,206 |
| CaMg/NaCl | 90.3% | 11.0% | 145.1% | | 145.2% | 17.8% | 195.5% |

### Example 2

### Computational Simulation

A multivalent-ion rich stream can be produced by a multistage nanofiltration system, such as a multistage nanofiltration system with twelve NF units. A computer simulation of such a system was run. When NF1 was fed with saline source water, 13.2 weight % of a combination of Ca²⁺, Mg²⁺, Na⁺, SO₄²⁻ and Cl⁻ may be produced in the first NF1 reject stream with 75% of RR. The properties of the reject streams, the RR of each NF unit, and the amount of dilution with distilled water at each NF unit was calculated and presented in Tables 3 and 4.

TABLE 3

| NF Unit No. | RR % | Dilution | CaMg/NaCl % |
|---|---|---|---|
| 1 | 75 | | (5.6 Seawater) 13.2 |
| 2 | 30 | 0.02 | 16.7 |
| 3 | 30 | 0.36 | 21.3 |
| 4 | 30 | 0.36 | 27.2 |
| 5 | 30 | 0.35 | 34.6 |
| 6 | 30 | 0.37 | 44.9 |
| 7 | 30 | 0.37 | 58.1 |
| 8 | 30 | 0.37 | 75.2 |
| 9 | 30 | 0.36 | 97.3 |
| 10 | 30 | 0.38 | 125.4 |
| 11 | 30 | 0.37 | 161.2 |
| 12 | 30 | 0.39 | 206.8 |

TABLE 4

| | NF1 | NF1 | NF1 | Dilute | NF2 | NF2 | NF2 | Dilute |
|---|---|---|---|---|---|---|---|---|
| | Feed | Perm | Rej | 1 | Feed | Perm | Rej | 2 |
| Flow | 390.60 | 292.95 | 97.65 | 2.00 | 99.65 | 29.90 | 69.76 | 25.00 |
| Ca++ | 450 | 245 | 1,066 | 20 | 1,045 | 508 | 1,275 | 20 |
| Mg++ | 1,500 | 249 | 5,254 | 0 | 5,149 | 764 | 7,028 | 0 |
| Na+ | 12,642 | 11,471 | 16,156 | 2 | 15,832 | 14,655 | 16,337 | 2 |
| K+ | 480 | 436 | 613 | 0 | 601 | 556 | 620 | 0 |
| Sr++ | 8 | 4 | 19 | 0 | 18 | 11 | 22 | 0 |
| CO3−− | 28 | 28 | 28 | | 27 | 27 | 27 | |
| HCO3− | 160 | 94 | 358 | 61 | 352 | 202 | 416 | 61 |
| SO4−− | 3,500 | 21 | 13,938 | 0 | 13,658 | 79 | 19,478 | 0 |
| Cl− | 22,400 | 19,261 | 31,818 | 3 | 31,180 | 26,293 | 33,274 | 3 |
| F− | 2 | 2 | 2 | 0 | 2 | 2 | 2 | 0 |
| NO3− | 2 | 1 | 5 | 1 | 5 | 3 | 6 | 1 |
| B | 6 | 5 | 6 | 1 | 5 | 6 | 5 | 1 |
| Br− | 60 | 52 | 85 | 0 | 84 | 70 | 89 | 0 |
| TDS | 41,237 | 31,867 | 69,348 | 88 | 67,958 | 43,176 | 78,578 | 88 |
| CaMg/Na | 5.6% | 1.6% | 13.2% | | 13.2% | 3.1% | 16.7% | |
| Cl | | | | | | | | |

| | NF3 | NF3 | NF3 | Dilute | NF4 | NF4 | NF4 |
|---|---|---|---|---|---|---|---|
| | Feed | Perm | Rej | 3 | Feed | Perm | Rej |
| Flow | 94.76 | 28.43 | 66.33 | 24.00 | 90.33 | 27.10 | 63.23 |
| Ca++ | 944 | 459 | 1,151 | 20 | 851 | 414 | 1,038 |
| Mg++ | 5,174 | 768 | 7,062 | 0 | 5,186 | 769 | 7,079 |
| Na+ | 12,027 | 11,133 | 12,410 | 2 | 9,113 | 8,436 | 9,404 |
| K+ | 457 | 423 | 471 | 0 | 346 | 320 | 357 |
| Sr++ | 16 | 9 | 19 | 0 | 14 | 8 | 16 |
| CO3−− | 20 | 20 | 20 | | 15 | 15 | 15 |
| HCO3− | 322 | 185 | 381 | 61 | 296 | 170 | 350 |
| SO4−− | 14,339 | 83 | 20,448 | 0 | 15,015 | 87 | 21,413 |
| Cl− | 24,496 | 20,657 | 26,141 | 3 | 19,196 | 16,188 | 20,486 |
| F− | 2 | 1 | 2 | 0 | 1 | 1 | 1 |
| NO3− | 4 | 3 | 5 | 1 | 4 | 2 | 5 |
| B | 4 | 4 | 4 | 1 | 4 | 4 | 3 |
| Br− | 66 | 55 | 70 | 0 | 51 | 43 | 55 |
| TDS | 57,870 | 33,799 | 68,185 | 88 | 50,092 | 26,457 | 60,222 |
| CaMg/NaCl | 16.8% | 3.9% | 21.3% | | 21.3% | 4.8% | 27.2% |

| | Dilute | NF5 | NF5 | NF5 | Dilute | NF6 | NF6 | NF6 | Dilute |
|---|---|---|---|---|---|---|---|---|---|
| | 4 | Feed | Perm | Rej | 5 | Feed | Perm | Rej | 6 |
| Flow | 22.00 | 85.23 | 25.57 | 59.66 | 22.00 | 81.66 | 24.50 | 57.16 | 21.00 |
| Ca++ | 20 | 775 | 377 | 946 | 20 | 697 | 256 | 886 | 20 |
| Mg++ | 0 | 5,252 | 779 | 7,168 | 0 | 5,237 | 600 | 7,224 | 0 |
| Na+ | 2 | 6,977 | 6,458 | 7,199 | 2 | 5,260 | 5,125 | 5,318 | 2 |
| K+ | 0 | 265 | 245 | 273 | 0 | 200 | 195 | 202 | 0 |
| Sr++ | 0 | 12 | 7 | 14 | 0 | 10 | 6 | 12 | 0 |
| CO3−− | | 11 | 11 | 11 | | 8 | 8 | 8 | |
| HCO3− | 61 | 275 | 158 | 325 | 61 | 254 | 141 | 302 | 61 |
| SO4−− | 0 | 15,886 | 92 | 22,655 | 0 | 16,551 | 91 | 23,606 | 0 |
| Cl− | 3 | 15,198 | 12,816 | 16,219 | 3 | 11,850 | 9,743 | 12,753 | 3 |
| F− | 0 | 1 | 1 | 1 | 0 | 1 | 1 | 1 | 0 |
| NO3− | 1 | 4 | 2 | 4 | 1 | 3 | 2 | 4 | 1 |
| B | 1 | 3 | 3 | 3 | 1 | 2 | 2 | 3 | 1 |
| Br− | 0 | 41 | 34 | 43 | 0 | 32 | 26 | 34 | 0 |
| TDS | 88 | 44,700 | 20,984 | 54,863 | 88 | 40,107 | 16,197 | 50,353 | 88 |
| CaMg/NaCl | | 27.2% | 6.0% | 34.6% | | 34.7% | 5.8% | 44.9% | |

| | NF7 | NF7 | NF7 | Dilute | NF8 | NF8 | NF8 |
|---|---|---|---|---|---|---|---|
| | Feed | Perm | Rej | 7 | Feed | Perm | Rej |
| Flow | 78.16 | 23.45 | 54.71 | 20.00 | 74.71 | 22.41 | 52.30 |
| Ca++ | 653 | 240 | 830 | 20 | 613 | 225 | 780 |
| Mg++ | 5,283 | 606 | 7,288 | 0 | 5,337 | 612 | 7,362 |
| Na+ | 3,890 | 3,790 | 3,932 | 2 | 2,880 | 2,806 | 2,912 |
| K+ | 148 | 144 | 149 | 0 | 109 | 107 | 111 |
| Sr++ | 9 | 5 | 11 | 0 | 8 | 5 | 9 |
| CO3−− | 6 | 6 | 6 | | 4 | 4 | 4 |
| HCO3− | 238 | 132 | 283 | 61 | 224 | 124 | 266 |
| SO4−− | 17,264 | 95 | 24,622 | 0 | 18,031 | 99 | 25,716 |
| Cl− | 9,328 | 7,669 | 10,038 | 3 | 7,352 | 6,045 | 7,912 |
| F− | 1 | 1 | 1 | 0 | 0 | 0 | 0 |
| NO3− | 3 | 2 | 4 | 1 | 3 | 2 | 4 |
| B | 2 | 2 | 2 | 1 | 2 | 2 | 2 |
| Br− | 25 | 21 | 27 | 0 | 20 | 16 | 21 |
| TDS | 36,849 | 12,712 | 47,193 | 88 | 34,584 | 10,047 | 45,099 |
| CaMg/NaCl | 44.9% | 7.4% | 58.1% | | 58.2% | 9.5% | 75.2% |

| | Dilute | NF9 | NF9 | NF9 | Dilute | NF10 | NF10 | NF10 | Dilute |
|---|---|---|---|---|---|---|---|---|---|
| | 8 | Feed | Perm | Rej | 9 | Feed | Perm | Rej | 10 |
| Flow | 19.00 | 71.30 | 21.39 | 49.91 | 19.00 | 68.91 | 20.67 | 48.24 | 18.00 |
| Ca++ | 20 | 577 | 212 | 734 | 20 | 537 | 127 | 713 | 20 |
| Mg++ | 0 | 5,400 | 619 | 7,450 | 0 | 5,396 | 458 | 7,512 | 0 |
| Na+ | 2 | 2,136 | 2,082 | 2,160 | 2 | 1,565 | 1,576 | 1,560 | 2 |
| K+ | 0 | 81 | 79 | 82 | 0 | 59 | 60 | 59 | 0 |
| Sr++ | 0 | 7 | 4 | 8 | 0 | 6 | 4 | 6 | 0 |
| CO3−− | | 3 | 3 | 3 | | 2 | 2 | 2 | |
| HCO3− | 61 | 211 | 118 | 252 | 61 | 199 | 99 | 242 | 61 |
| SO4−− | 0 | 18,863 | 104 | 26,902 | 0 | 19,485 | 93 | 27,796 | 0 |
| Cl− | 3 | 5,805 | 4,772 | 6,247 | 3 | 4,525 | 3,417 | 5,000 | 3 |
| F− | 0 | 0 | 0 | 0 | 0 | 0 | 0 | 0 | 0 |
| NO3− | 1 | 3 | 2 | 3 | 1 | 3 | 1 | 3 | 1 |
| B | 1 | 2 | 2 | 2 | 1 | 2 | 2 | 2 | 1 |
| Br− | 0 | 16 | 13 | 17 | 0 | 12 | 9 | 13 | 0 |
| TDS | 88 | 33,105 | 8,009 | 43,860 | 88 | 31,791 | 5,848 | 42,909 | 88 |
| CaMg/NaCl | | 75.3% | 12.1% | 97.3% | | 97.4% | 11.7% | 125.4% | |

| | NF11 | NF11 | NF11 | Dilute | NF12 | NF12 | NF12 | Dilute |
|---|---|---|---|---|---|---|---|---|
| | Feed | Perm | Rej | 11 | Feed | Perm | Rej | 12 |
| Flow | 66.24 | 19.87 | 46.37 | 18.00 | 64.37 | 19.31 | 45.06 | 0.00 |
| Ca++ | 524 | 124 | 696 | 20 | 507 | 120 | 673 | 20 |
| Mg++ | 5,471 | 464 | 7,616 | 0 | 5,486 | 465 | 7,638 | 0 |
| Na+ | 1,137 | 1,145 | 1,133 | 2 | 817 | 823 | 814 | 2 |
| K+ | 43 | 44 | 43 | 0 | 31 | 31 | 31 | 0 |
| Sr++ | 5 | 3 | 5 | 0 | 4 | 3 | 4 | 0 |
| CO3−− | 2 | 2 | 2 | | 1 | 1 | 1 | |
| HCO3− | 193 | 96 | 234 | 61 | 186 | 93 | 226 | 61 |
| SO4−− | 20,242 | 97 | 28,876 | 0 | 20,801 | 99 | 29,673 | 0 |
| Cl− | 3,642 | 2,750 | 4,024 | 3 | 2,900 | 2,190 | 3,204 | 3 |
| F− | 0 | 0 | 0 | 0 | 0 | 0 | 0 | 0 |
| NO3− | 3 | 1 | 3 | 1 | 3 | 1 | 3 | 1 |
| B | 2 | 2 | 2 | 1 | 2 | 1 | 2 | 1 |
| Br− | 10 | 7 | 11 | 0 | 8 | 6 | 9 | 0 |
| TDS | 31,272 | 4,734 | 42,646 | 88 | 30,744 | 3,833 | 42,278 | 88 |
| CaMg/NaCl | 125.5% | 15.1% | 161.2% | | 161.3% | 19.4% | 206.8% | |

| | NF13 | NF13 | NF13 |
|---|---|---|---|
| | Feed | Perm | Rej |
| Flow | 45.06 | 0.00 | 45.06 |
| Ca++ | 673 | 160 | 673 |
| Mg++ | 7,638 | 648 | 7,638 |
| Na+ | 814 | 820 | 814 |
| K+ | 31 | 31 | 31 |
| Sr++ | 4 | 3 | 4 |
| CO3−− | 1 | 1 | 1 |
| HCO3− | 226 | 113 | 226 |
| SO4−− | 29,673 | 141 | 29,673 |
| Cl− | 3,204 | 2,419 | 3,204 |
| F− | 0 | 0 | 0 |
| NO3− | 3 | 2 | 3 |
| B | 2 | 1 | 2 |
| Br− | 9 | 6 | 9 |
| TDS | 42,278 | 4,346 | 42,278 |
| CaMg/NaCl | 206.8% | 24.9% | 206.8% |

1. A method to increase a ratio of multivalent ions to monovalent ions in a retentate of a multistage nanofiltration system, the method comprising:
filtering a saline source water through a plurality of nanofiltration (NF) units in series, wherein each of the plurality of NF units in the series receives a feed water and forms a NF permeate stream and a NF retentate stream, wherein the feed water of a first NF unit of the plurality of NF units comprises the saline source water; and
optionally diluting the NF retentate stream from one or more of the plurality of NF units with a diluent water to form a diluted NF retentate stream comprising a ratio of the diluent water to the NF retentate stream of 0:1 to 5:1, and wherein the diluent water comprises a total dissolved solids (TDS) concentration lower than a TDS concentration of the saline source water, and
filtering the NF retentate stream and/or diluted NF retentate stream through one or more of the plurality of NF units, wherein the plurality of NF units are configured such that the feed water for NF units downstream of the first NF unit comprises a NF retentate stream and/or diluted NF retentate stream, and
wherein, the volume of the NF permeate stream divided by the volume of the feed water provides a recovery rate (RR), the RR of the first NF unit is greater than the RR of one or more of the subsequent NF units in the series, wherein the RR of the first NF unit is greater than about 60%, the RR of an optional intermediate NF unit in the series is about 20-60%, and the RR of a last NF unit in the series is less than about 60%.

2. The method of claim 1, wherein the series comprises at least three NF units, and wherein the filtering comprises a RR of the first NF unit of about 60-80%, the RR of a second and/or one or more intermediate NF unit(s) of about 20-60%, and the RR of the last NF unit of about 20-60%.

3. The method of claim 1, wherein the series comprises at least four NF units, and wherein the filtering comprises a RR of the first NF unit of about 70-80%, the RR for a second NF unit of about 45-55%, the RR for a third NF unit of about 45-55%, and the RR for the last NF unit of about 25-35%.

4. The method of claim 1, wherein the NF retentate stream from the last NF unit comprises a ratio of multivalent ions to monovalent ions that is increased by at least 200% as compared to a ratio of multivalent ions to monovalent ions in the saline source water.

5. The method of claim 1, wherein the NF retentate stream from the last NF unit comprises a concentration of Na at least 10 times lower than the saline source water and a concentration of Cl at least 10 times lower than the saline source water.

6. The method of claim 1, wherein diluting one or more of the NF retentate streams does not produce a diluted NF retentate stream comprising a multivalent ion scaling concentration of CaSO₄ that is greater than 250% of a CaSO₄ saturation concentration.

7. The method of claim 1, wherein one or more of the NF unit(s) further comprise at least 2 nanofiltration stages.

8. The method of claim 1, wherein the first NF unit is configured to receive greater than or equal to about two times an amount of feed water flow or volume relative to one or more downstream NF unit(s), and/or the first NF unit comprises greater than or equal to about two times a number of pressure vessels in the first NF unit relative to a number of pressure vessels in one or more downstream NF unit(s).

9. The method of claim 1, wherein the NF retentate stream from one or more of the plurality of NF units is mixed with the diluent water to form a diluted NF retentate stream comprising a ratio of the diluent water to the NF retentate of less than 2:1.

10. The method of claim 1, further comprising recirculating at least a portion of a NF retentate stream from one or more of the NF units into the feed water of at least one upstream NF unit.

11. A system to increase a ratio of multivalent ions to monovalent ions in a retentate of a multistage nanofiltration system, the system comprising:
a plurality of nanofiltration (NF) units in series, wherein each of the plurality of NF units in the series are configured to receive a feed water and form a NF permeate stream and a NF retentate stream, wherein the feed water of a first NF unit of the plurality of NF units is configured to receive a saline source water; and
optionally the plurality of NF units are configured such that the NF retentate stream from one or more of the plurality of NF units can be mixed with a diluent water having a total dissolved solids (TDS) concentration lower than a TDS concentration of the saline source water, to form a diluted NF retentate stream comprising a ratio of the diluent water to the NF retentate stream of 0:1 to 5:1,
wherein the plurality of NF units are configured such that the feed water for NF units downstream of the first NF unit comprises a NF retentate stream and/or diluted NF retentate stream, and
wherein, the volume of the NF permeate stream divided by the volume of the feed water provides a recovery rate (RR), the RR of the first NF unit is greater than the RR of one or more of the subsequent NF units in the series, wherein the RR of the first NF unit is greater than about 60%, the RR of an optional second and/or an intermediate NF unit in the series is about 20-60%, and the RR of a last NF unit in the series is less than about 60%.

12. The system of claim 11, wherein the series comprises at least three NF units, and wherein the RR of the first NF unit is about 60-80%, the RR of a second NF unit and/or an intermediate NF unit(s) is about 20-60%, and the RR of the last NF unit is about 20-60%.

13. The system of claim 12, wherein the series comprises at least four NF units, and wherein the RR for the first NF unit is about 70-80%, the RR for a second NF unit is about 45-55%, the RR for a third NF unit is about 45-55%, and the RR for the last NF unit is about 25-35%.

14. The system of claim 11, wherein the system is configured such that the NF retentate stream from the last NF unit comprises a ratio of multivalent ions to monovalent ions that is increased by at least 200% as compared to a ratio of multivalent ions to monovalent ions in the saline source water.

15. The system of claim 11, wherein the system is configured such that the NF retentate stream from the last NF unit comprises a concentration of Na at least 10 times lower than the saline source water and a concentration of Cl at least 10 times lower than the saline source water.

16. The system of claim 11, wherein the system is configured such that diluting one or more of the NF retentate streams does not produce a diluted NF retentate stream comprising a multivalent ion scaling concentration of CaSO₄ that is greater than 250% of a CaSO₄ saturation concentration.

17. The system of claim 11, wherein one or more of the NF units further comprise at least 2 nanofiltration stages.

18. The system of claim 11, wherein the first NF unit is configured to receive greater than or equal to about two times an amount of feed water flow or volume relative to one or more downstream NF unit(s), and/or the first NF unit comprises greater than or equal to about two times the number of pressure vessels relative to one or more of the downstream NF unit(s).

19. The system of claim 11, wherein the NF retentate stream from one or more of the plurality of NF units is configured to be mixed with the diluent water to form a diluted NF retentate stream comprising a ratio of the diluent water to the NF retentate of less than 2:1.

20. The system of claim 11, further comprising piping for recirculating at least a portion of the NF retentate stream from one or more of the NF units into the feed water of at least one upstream NF unit.
